(19) United States
(12) Patent Application Publication
(10) Pub. No.: US 2021/0321022 A1
(43) Pub. Date: Oct. 14, 2021

(54) MEANS AND APPARATUS FOR ENHANCING VISIBILITY OF PROXIMATE SUBSURFACE FEATURES FOR VESSEL

(71) Applicant: Ricky Galante, Clearwater, FL (US)

(72) Inventor: Ricky Galante, Palm Harbor, FL (US)

(21) Appl. No.: 16/846,215

(22) Filed: Apr. 10, 2020

(51) Int. Cl. H04N 5/225; H04N 5/232; H04N 7/18; B63B 79/15; B63B 35/14; G03B 17/56

(52) U.S. Cl. CPC H04N 5/2253; H04N 5/23299; H04N 7/183; G03B 17/561; B63B 79/15; B63B 35/14; H04N 5/23203

(57) ABSTRACT

Apparatus and means are provided for elevating a video camera above the deck of a vessel in order to achieve a better and more distant view of objects below the surface of the water. The apparatus provides for allowing a video camera to be elevated, aimed in any horizontal direction, and further tilted from substantially straight down into the water to substantially straight up into the sky. The apparatus further provides for such a tower of fixed elevation or one which may be adjustable and elevation. Further it provides for either manual or remote adjustment of the horizontal direction, vertical tilt, elevation, or for the zoom or aperture of the video camera. It also provides for viewing the image either on one or more fixed video monitors or upon the screen of a computing device, such as a smart phone, tablet, or any form of computer which are adapted with any form of wireless, such as Wi-Fi or Bluetooth.

### FIELD OF THE INVENTION

The invention relates to visual detection by means of photographic or video graphic enhancement of fish and other objects beneath the surface of a body of water.

### BACKGROUND OF THE INVENTION

Navigation of vessels, such as personal vessel or commercial fishing vessel, is often undertaken for the purpose of either catching or viewing fish or seafood or for viewing underwater features, such as coral reefs, rock formations or historical artifacts. The ability to find such objects quickly and with precision substantially is critical to accomplishing these tasks.

In the past vessels may be equipped with some form of tower which could be ascended by the ship's captain or a crew member who may further be equipped with some form of optical devices such as binoculars or a telescope in order to spot such objects and features. If such a vessel did not have crew members or passengers who could send the tower or otherwise have the assistance of a person capable of controlling or steering the vessel for a short time, then the vessel's captain his or herself would have to send the tower and could do so either in calm waters or by dropping anchor with the vessel.

It would be helpful to identify a means or apparatus where in the captain of a vessel could simultaneously pilot the vessel and have the benefit of such an enhanced view so as to either find fish, identify potential underwater hazards, or identify such other underwater features or historical artifacts.

In the past, solutions undertaken to resolve this problem have included such things as radar and sonar, which are capable of providing limited identification of direction, depth and to some measure the detection of the size of subject objects, none of these enable the captain of the vessel to identify with a sufficient degree of certainty the direction, depth, size and identity of such objects. Such capabilities would enable the captain of the vessel to quickly locate and navigate either to or around such features as desired. With the present invention the inventor has provided means an apparatus for substantially enhancing the ability of the captain of a vessel to accomplish these tasks. Even in very clear water viewing such underwater, or subsurface objects is limited to a finite distance from the vessel because of the refraction of light as it passes from the water medium into air medium.

It is well-known that when light encounters a boundary between two media, such as air and water, a certain amount of the light is reflected and a certain amount is refracted. It is also well known that as the angle of the light to be transmitted through such surfaces is greater (considering that such object is directly below the observation point is 90° at X distance and the observation angle becomes smaller as the observation point gets more distant from the underwater object down to 0° if the object is attempted to be viewed from the surface of the water at the same distance X) the light from underwater object transmitted through the surface boundary will become more refracted until at some angle between 0° and 90° all of the light from the underwater object will actually be reflected back underwater and the object will not be seen from above the surface.

It can also be seen that if the observation point is elevated, then the observation range between the underwater object and the observation point will be greater because the same observation angle will encompass a greater viewing radius. For instance, if the purpose of the trip were to locate fish, the ability to substantially increase the range of observation from the vessel would make it easier to locate and approach the location of fish with the vessel.

Accordingly, light from underwater objects can be detected from a greater distance from an elevated point on the vessel. Accordingly, if the pilot, crew or passengers aboard a vessel had some way of elevating the point from which they made observations of underwater objects they would have a better chance of detecting schools of fish, individual fish, underwater hazards, or any underwater point of interest.

What is not provided in the prior art are means and apparatus for permitting a person to quickly scan the underwater areas in a much broader area than presently available. Such is done by elevating a video camera so that images from the video camera may be transmitted to a video monitor. The increased elevation of said video camera permits a person on board the vessel to quickly scan the surrounding waters at a greater distance for the existence of fish or other objects. Additionally, the video camera may be enhanced by magnification or light filtration for even improved surveillance of the surrounding waters. These observations may be used to determine a desired course of the vessel for the purpose of fishing, safe navigation, or location.

### SUMMARY OF THE INVENTION

The inventor has resolved this problem by enabling the pilot of the vessel to substantially improve the ability to locate and identify such subsurface features of a body of water proximate to the vessel. This has been done by providing a means of securely mounting a video camera so that it may be elevated and aimed in a variety of directions and also tilted in such a manner to select either a near view or more distant view as within the capability of the video camera and the conditions of light and clarity of the proximate water.

Accordingly, the basic invention comprises an elevated tower which may, but need not be, adjustable with respect to the degree of elevation, upon which a video camera may be securely mounted. By means of controls, which may include simple manual positioning and adjustment of the elevation and camera angle, the elevation of the tower may (but need not) be adjusted, the direction of the video camera may be adjusted and the tilt of the video camera (or vertical orientation of the video camera) may also be adjusted. Moreover, by selecting the video camera type or augmenting the video camera with stability means, such as a gyroscope, such vision may be substantially enhanced. Finally, the invention comprises a video monitor by which a pilot, crew member, or passenger may view the images of the video camera.

Having generally described the basic components of the preferred embodiment of the present invention, it is now appropriate to mention that there are a variety of optional or alternative means an apparatus for adapting the invention for more convenient, efficient, or appropriate ways to deploy the invention under different circumstances or to achieve different goals. Each such alternative means, which will be described in more detail in the accompanying figures and detailed description, will comprise the basic elements of the invention as described above but will also provide for alternative means of mounting, controlling, and viewing the video images. It will be seen that each such alternative is in keeping within the spirit and scope of the invention and its accompanying claims.

Additionally, the means and components for effecting such control over the apparatus may include simple mechanical control of the video camera positioning and orientation by pulleys, levers and hand cranks or, for instance, simply twisting the shaft or by lowering the video camera mount to adjust the tilt manually. However, such functions may be substantially enhanced by using either electrical wire or electromagnetic wireless communication or a combination of electrical and electromagnetic wireless communication between a control device and the various video camera controls which may be accomplished by a cellular telephone or wireless tablet adapted with an application (or app) adapted to facilitate such controls. Additionally, viewing the video image from the video camera may also be accomplished by a fixed monitor, with or without being in further communication with such viewing methods as a tablet or cellular telephone.

It is then, an object of the present invention to provide a means an apparatus for an operator, who may but need not be the captain of the vessel, to be able to view on a video monitor and in real time underwater features for the existence of fish through greater distances proximate to a vessel by means of elevating and controlling a video camera.

It is a further object of the present invention to provide such a means an apparatus for an operator, who may but need not be the captain of the vessel, to be able to view on a video monitor and in real time underwater features for the existence of fish through greater distances proximate to a vessel by means of elevating and controlling a video camera in which the elevation of the video camera may be adjusted by means of a telescoping shaft.

It is a further object of the present invention to provide such a means an apparatus for an operator, who may but need not be the captain of the vessel, to be able to view on a video monitor and in real time underwater features for the existence of fish through greater distances proximate to a vessel by means of elevating and controlling a video camera in which the elevation of the video camera may be adjusted by means of a telescoping shaft and in which the view may be further enhanced by adapting the tower with an extension arm which may extend out in a substantially perpendicular manner so as to have a more direct view of shallow waters, such as along the shoreline.

It is then, a further object of the present invention to provide a means an apparatus for an operator, who may but need not be the captain of the vessel, to be able to view on a video monitor and in real time underwater features for the existence of fish through greater distances proximate to a vessel by means of elevating and controlling a video camera by means of any of the above described methods and further enhance such viewing by means an apparatus for stabilizing the video camera in waters which are not still or calm.

It is then, a further object of the present invention to provide a means an apparatus for an operator, who may but need not be the captain of the vessel, to be able to achieve an enhanced view on a video monitor and in real time underwater features for the existence of fish through greater distances proximate to a vessel by means of elevating and controlling a video camera by means of any of the above described methods and further enhance such viewing by means of adapting a video camera with filtered lenses so as to eliminate degradation of the video image by fog, glare or by tint of the water from impurities or other coloring of the water by natural or artificial means. It is then, a further object of the present invention to provide a means an apparatus for an operator, who may but need not be the captain of the vessel, to be able to achieve an enhanced view on a video monitor and in real time underwater features for the existence of fish through greater distances proximate to a vessel by means of elevating and controlling a video camera by means of any of the above described methods and further enhance such viewing by means of selecting a special-purpose video camera, such as night vision, to make observations not normally available in sunlight.

Other features and advantages of the present invention will be apparent from the following description in which the preferred embodiments have been set forth in conjunction with the accompanying drawings.

### BRIEF DESCRIPTION OF THE DRAWINGS

In describing the preferred embodiments of the invention reference will be made to the series of figures and drawings briefly described below.

FIG. 1 depicts a side view of the preferred embodiment of the present invention mounted upon a small vessel.

FIG. 2A depicts a mount for the preferred embodiment for mounting the apparatus alongside the hull of the vessel.

FIG. 2B depicts a mount for the preferred embodiment for mounting the apparatus upon the deck alongside the wheel of the vessel.

FIG. 3A depicts a cross sectional view of the elevation tower of the alternative version of the preferred embodiment which permits manual manipulation of the elevation of the camera.

FIG. 3B depicts another cross sectional view of the elevation tower of the alternative version of the preferred embodiment the which permits manual manipulation of the tilt view of the camera.

FIG. 4 depicts the alternative embodiment of the present invention in which the camera is mounted upon a telescoping tower, which expands to elevate and contracts to descend, but which does not, itself, rotate. Horizontal rotation to adjust aim of the video camera is achieved by remote rotation of the video camera mounting means.

FIG. 5A depicts, in isolation, the interior of a control shroud which further depicts adjustment motors for the horizontal direction and vertical tilt adjustments to the camera.

FIG. 5B depicts a video camera adapted with a shade to reduce direct sunlight from interfering with the video images transmitted from the video camera when its vertical tilt is horizontal or bellow.

FIG. 5C depicts a video camera mounting member, demonstrating where and how the control shroud is positioned.

FIG. 5D depicts a fully assembled video camera control means.

FIG. 6 depicts, in isolation, a shroud which may be mounted upon the top of the telescoping tower in order to protect the video camera and its accessories.

FIG. 7 depicts the alternative embodiment of the present invention in which a telescoping extension arm is mounted upon the the telescoping tower and the horizontal rotation of the telescoping arm is controlled by an electric motor within the cover of the telescoping extension arm mount and the vertical tilt of the camera is controlled by a motor within the camera shroud at the far end of the telescoping arm.

FIG. 7A depicts a control shroud within which an electric motor may be housed which is also used to mount upon the near end of an extension arm and remotely operated to cause the horizontal rotation of the aim of the camera mounted on the opposite end.

FIG. 7B depicts the video camera mounting apparatus at the far end of the extension arm, including the vertical tilt adjustment.

FIG. 7C depicts a camera mounted at the end of the extension arm embodiment with the interior thread mechanism cut out to demonstrate the mechanical communication between the video camera and the extension arm mount.

FIG. 8 depicts an alternate version of the preferred embodiment in which the elevation tower is mounted within a cylindrical sleeve positioned on the outward side of the hull of the vessel permitting it to be slid through the cylindrical sleeve in order to adjust the elevation of the camera either up or down.

FIG. 9 depicts a video monitor with controls with which the horizontal aim, vertical tilt, elevation, and zoom of the camera may be adjusted either electronically or wirelessly either through Bluetooth or Wi-Fi electromagnetic connection.

FIG. 10A depicts the screen of a smart phone equipped with an app in the adjustment mode with which a person may alternatively have remote wireless control over the camera positioning and orientation, the camera zoom and switch to viewing so that the user may then use the images from the adjusted camera.

FIG. 10B depicts the screen of a smart phone equipped with an app in the image mode with which a person may view the video image wirelessly transmitted from the video camera.

FIG. 11A schematically depicts the electronic communication between a control panel and the elevation adjustment, the horizontal angle adjustment, the vertical tilt adjustment, the camera zoom adjustment, and the video monitor.

FIG. 11B schematically depicts the electromagnetic wave communication between a smart phone, tablet, or computer adapted with wireless or Bluetooth capability, and the elevation adjustment, the horizontal angle adjustment, the vertical tilt adjustment, the camera zoom adjustment, and a monitor apart from the controlling device if supply.

FIG. 11C schematically depicts electromagnetic communication between a smart phone, a tablet, or wirelessly equipped computer and a control panel which is, as in FIG. 11A, in electrical communication with the elevation adjustment, the horizontal angle adjustment, the vertical adjustment, the camera zoom adjustment, and the video monitor.

While certain drawings have been provided in order to teach the principles and operation of the present invention, it should be understood that, in the detailed description which follows, reference may be made to components or apparatus which are not included in the drawings. Such components and apparatus should be considered as part of the description, even if not included in such a drawing. Likewise, the drawings may include an element, structure, or mechanism which is not described in the textual description of the invention which follows. The invention and description should also be understood to include such a mechanism, component, or element which is depicted in the drawing but not specifically described.

In other words, the detailed description should be seen to augment, rather than limit the drawings.

### DETAILED DESCRIPTION OF THE PREFERRED EMBODIMENT

Description will now be made in detail to the present preferred embodiment of the invention, an example of which is illustrated in the accompanying drawings. While the invention will be described in connection with a preferred embodiment, it will be understood that it is not intended to limit the invention to that embodiment. On the contrary, it is intended to cover all alternatives, modifications, and equivalents as may be included within the spirit and scope of the invention defined in the appended claims. Ion other words the drawings should be seen to augment rather than to limit this detailed description.

While the following description will seek to improve understanding of the invention by describing the various components and elements, it should be considered that certain apparatus may be sufficiently and adequately explained by the accompanying drawings, which are fully incorporated herein, and not require further description. All such apparatus should be considered as part of the specification of the invention for all purposes.

Although the invention is capable of use with a variety of vessels of many sizes it will be seen that it's greatest utility will be of vessels used to navigate local waters, such as bays, rivers, creeks, and lakes which are popular for recreational and in some cases commercial fishing. Additionally, the invention works best with clearer waters for reasons which will become obvious.

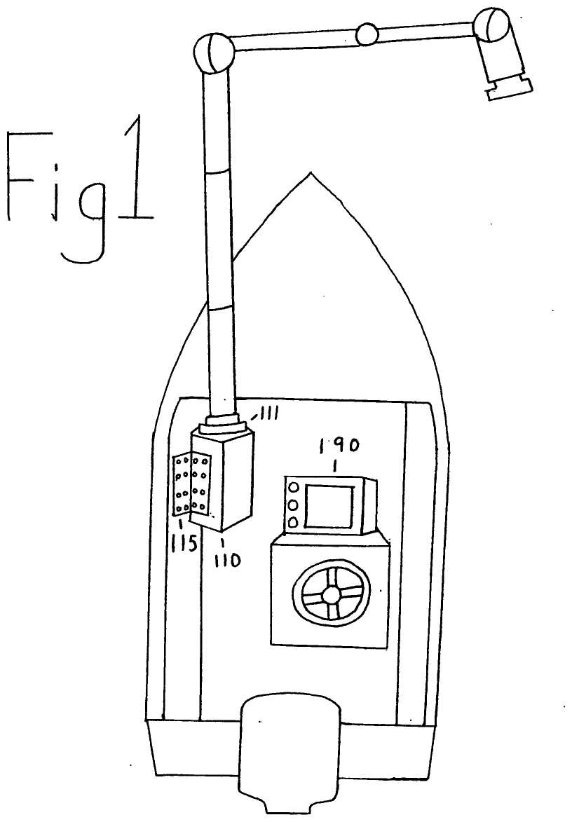

The essence of the invention is to provide a means of making observations of underwater objects from a greater distance than is presently available. It is also considered that such observations be made from deck level of a vessel and can also be made at any desired direction from the vessel. Accordingly, making reference first to FIG. 1, it is noted at the outset that the invention may be said to comprise as a minimum a tower mounting means (110), a substantially vertical cylindrical tower (130), a video camera mounting means (160), and a video monitor (190) with which the images from a video camera (170) mounted from the video camera mounting means (160) is mounted. From this all of the essential elements of the invention are presented and their functions can be described. The cylindrical tower (130) is held in place by a cylindrical mounting sleeve (111) but is not held in place so tightly that the cylindrical tower (130) cannot be rotated either clockwise or counterclockwise to achieve the desired direction of observation.

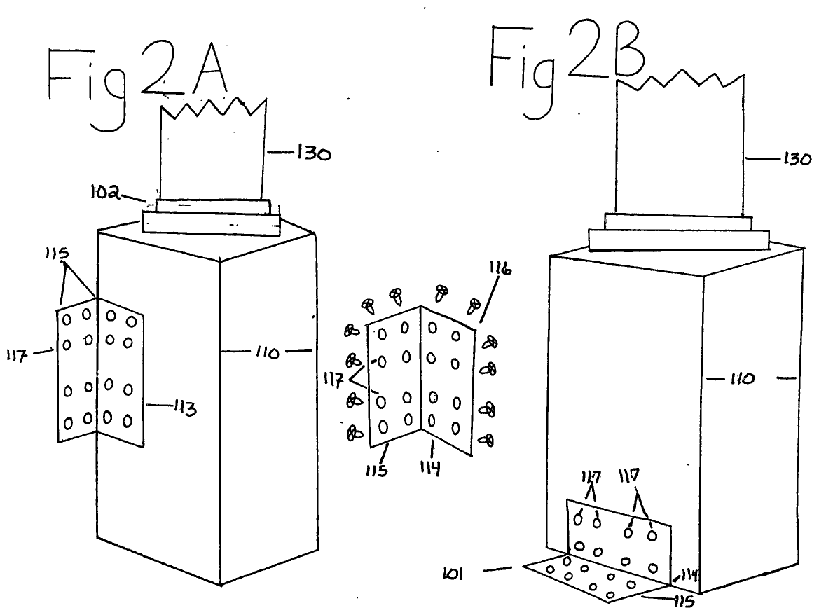

It should first be pointed out that the mounting means (110) as depicted in FIGS. 2A and 2B may be satisfied in a number of ways. In the preferred embodiment (FIG. 1) the mounting means (110) is mounted to a convenient vertical surface (115), as depicted in FIG. 2A such as the hull (102) by means of mounting brackets (113) elongated perpendicular sides (114) which are fastened to the hull (102) and the mounting means (110) by a series of holes (116) along each perpendicular side (115) of each mounting bracket (114). These holes (116) are adapted to receive a series of screws (117) which are driven through the holes (116) sufficiently tight to secure the elevation tower (130 to the hull (102) of the vessel (100). One or more shims (not depicted in FIG. 2A), between the mounting means (110) could be used to make the mounting means (110) hold the tower upright.

However, as depicted in FIG. 2B, the mounting means (110) could be positioned for mounting the elevation tower (110) may directly to the deck (101) of a ship by, which may be desirable if the device is to be positioned in a precise place within the vessel for use by the vessel's captain or a crew member Simply by reorienting the mounting brackets (114) are positioned horizontally to achieve the same secure mount to the deck (101) of the vessel (100) as was used to secure the mounting means (110) to the hull (102) in FIG. 2A.

The video camera mounting means (160) may further comprise a video camera mounting rod (161), which may further be securely mounted to the cylindrical elevation tower (130) at one end and comprise a vertical clamp (162) at the other end. Such vertical clamp (162) may further receive a video camera mounting assembly (163) which comprises a small rod (169) (which may be shaped to adapt to adapt to the mounting types of various video cameras) with a circular disk (164) at one end and a video camera mounting screw (176) at the other end. As many video cameras are adapted with interior threaded cavities (not depicted in FIG. 1) to be received by tripod mounts and the like, the video camera mounting screw (165) may be adapted to be received by such interior threaded cavities.

The circular disk (164) can then be positioned within the vertical clamp (162) between two clamping members (166), which are adapted with two clamp member holes (167) which are aligned with each other so that the vertical disc (164), also adapted with a vertical disc hole (168) through which a screw (169) can be positioned through the two clamp member holes (167) and the vertical disc hole (168) and tightened to securely hold the video camera (170) in a desired orientation with the clamp (163). The video camera (170) may be placed in electrical or electromagnetic communication with a video monitor so that the images taken by the video camera may be observed in real time. Such will allow the video camera (170) to be adjusted to a desired tilt angle between straight upwards (180°) to straight down words (0°) or, most frequently, at the most beneficial angle to view objects underwater, given the refraction of such objects as discussed above in the background of the invention.

Accordingly, it can be seen that by adapting a tower (130) of adequate length and mounting it to protrude upward from the deck (101) of a vessel (101) with a camera (170) so that a pilot or interested person can view images on a video monitor (190) taken from a camera (170) which is now elevated above the deck (101) of a vessel (100) and rotated to any desired direction that a pilot, crew or other interested passenger may desire.

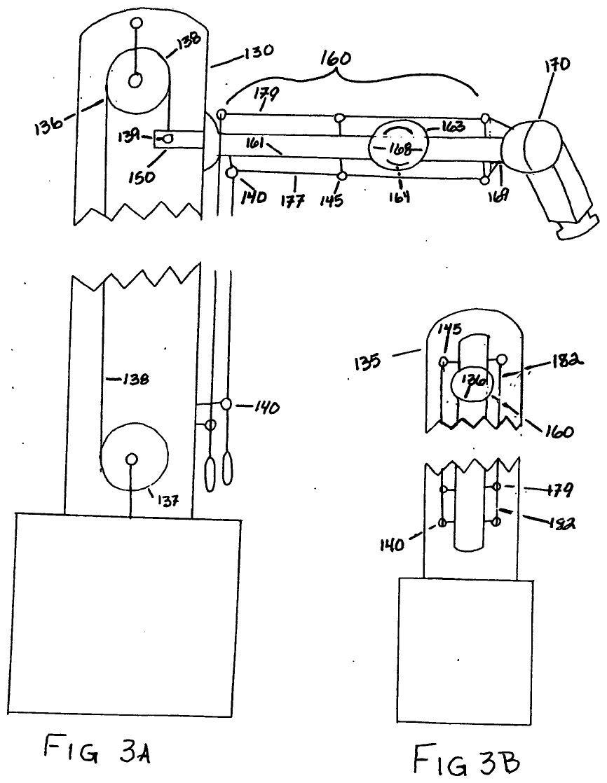

Such tower (130) could further be adapted to receive a video camera (170) which can be mounted to tilt in order to view the water at a given range. Making reference now to FIGS. 3A and 3B, it can be seen that certain enhancements to the basic camera mounting apparatus (160) and tower (130) may be added to make the apparatus easier and more efficient to use. For instance, a line (177) may be fastened to the lower side (178) of the video camera mounting rod (161) and may extend down to near the deck level (110) through a lower line guide (140) mounted upon the cylindrical tower (130) and may be used to pull said video camera piece down to adjust the aim of said video camera (170) down to a lower angle of observation. The video camera in this, as in all other embodiments of the present invention may be adapted with a shade (178). Since the vertical tilt of the video camera will almost always be at horizontal or lower (except when directed skyward, usually at night) such shade protects the video camera image from being diminished by stray sunlight.

Additionally, another line (179) could extend from the upper side (177) of the video camera mounting piece (143) and be run through an upper line guide (182) and then extended down near the deck level (110) and may be used to pull said video camera piece (164) up to adjust the aim of said video camera (170 back up to a higher angle of observation. Of course there may be other ways of remotely adjusting the tilt angle of the video camera (170) all of which should seen to be in keeping within the spirit and scope of the present invention and its claims.

Making reference to FIG. 3A, another cross sectional view of the cylindrical tower (130), and as it may be desirable to adjust either the elevation of the video camera (170) or its tilt angle, as described above, simple adaptations can be made to the cylindrical tower (130) or to the camera mounting apparatus (160) in order to provide a pilot or other interested person aboard the vessel to make such adjustments from the deck level (101). FIG. 3A depicts a the cross-section of cylindrical tower (130) which has been adapted with an upper shaft pulley (136) and lower shaft pulley (137) about which an elevating line (138) is stretched tightly.

Making reference to FIG. 3A, another enhancement of the apparatus would comprise a means and method for raising and lowering the video camera apparatus (160) remotely. The cylindrical tower (131) depicted here further comprises an elongated slot (132) running through a partial length of the cylindrical tower (131) from near its highest elevation (133) to a point (134) to a point near the cylindrical mounting sleeve (111).

By means of a connecting piece (150) the elevating line (138) is firmly clamped to the camera mount (160) with a line clamp (139). The connecting member (145) between the line clamp (139) is adapted to narrowly fit through the cylindrical shaft elongated slot (132). The lower shaft pulley (137) is adapted with an axle (139) which passes through the interior of the cylindrical tower (130) and allows the line to be moved so that the camera mount (160) with the camera (170) can be moved to a desired elevation point along the cylindrical shaft (131).

It can now be seen that the inventor has developed a system whereby a video camera may be elevated above the deck of any desired point on a vessel from being mounted just on the outside of the hull to just on the inside of the whole or at any given point upon the deck of the vessel. Moreover it comprises a video camera which can be aimed in any horizontal direction or virtually any vertical tilt. Accordingly, the apparatus offers a view of the surrounding water, or it could be used to offer a view of the vessel traffic behind or on any side of the vessel, or in the evening it could offer a view of the sky for navigation by the stars. Additionally, it could be used to scan the surface of the vessel to check on the welfare of passengers or to take pictures of events on the vessel for recreation or documentation purposes.

Moreover, the adjustments to such things as video camera elevation, direction, or tilt can all be made from the deck of the vessel. A video monitor can be positioned at any point desired, commonly accessible to the pilot at the wheel of the vessel. However, it could be located at any other point or multiple monitors could be provided at different points on the vessel depending upon the size of the vessel and the number of passengers and crew aboard.

In alternate embodiments of the invention additional features may be offered to further enhance the operation of the present invention. For instance, it may be desirable for the captain to be able to operate the device and adjust the elevation, the direction and the tilt of the camera without leaving the pilot station. For this, automated controls for these settings can be provided within a control panel which may or may not be integral with a video monitor and automated controls for the direction of the camera and the tilt angle of the camera. Such enhancements would ordinarily be more practical for use on larger vessels, but it will be seen that such enhancements could also be applied to the most basic forms of the invention as described above.

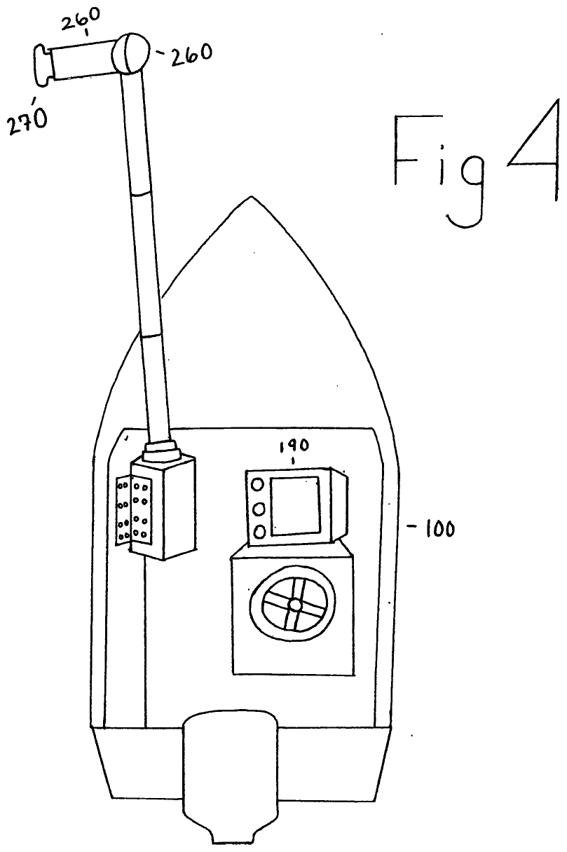

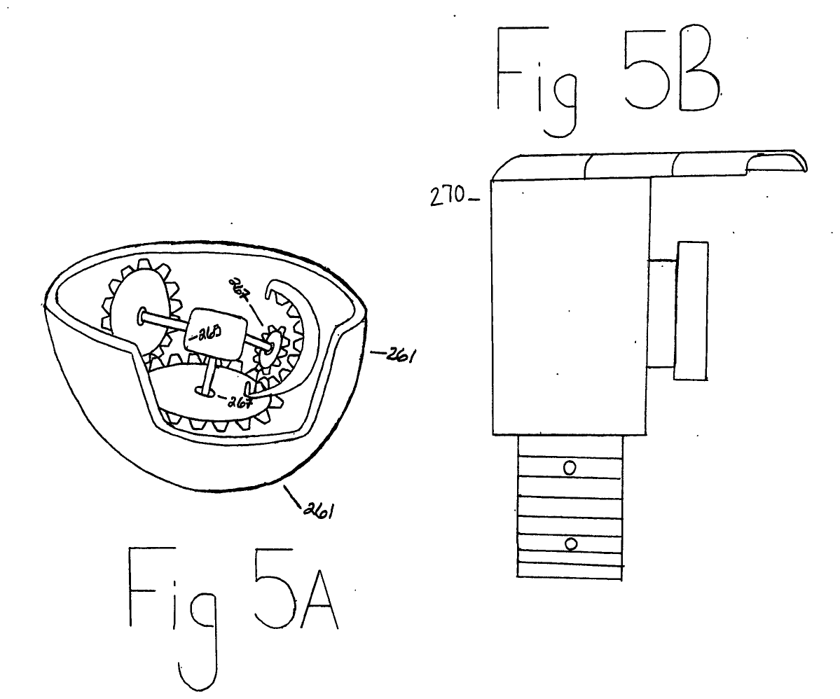

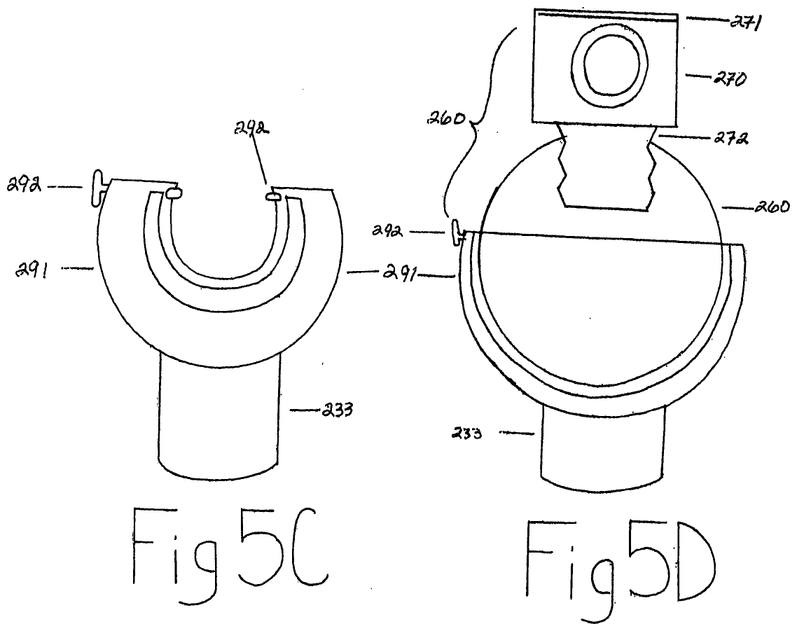

Making reference first to FIG. 4, it can be seen that the first described alternative embodiment of the present invention comprises a telescoping tower (230), a video camera mounting assembly, (260), such video camera assembly (260) being further adapted with motors and gears (depicted in FIG. 5A) which will enable a video camera (270) to be remotely controlled from a control mechanism also not depicted in FIG. 4 which may, but need not, be housed within the video camera mounting assembly (260). Additionally, a monitoring screen with control panel (290) is provided for use in viewing images from the video camera assembly (270).

It would now desirable to describe the telescoping tower (230) in more detail. As depicted in FIG. 4, the telescoping tower (230) comprises a series of telescoping members (231-233) which may be expanded out apart from each other or contracted back into one another in order to achieve a desirable vertical position.

Making now reference to FIG. 5A an alternative embodiment the video camera adjustment assembly (260) is shown. A notable difference between the primary preferred embodiment of the invention is that the telescoping tower (230) does not rotate but the video camera mounting means (260) does rotate at the top of the telescoping tower (260). One or two electric motors (264), (265) are in electronic or electromagnetic communication with a control panel for remote control. One of these motors (265) drives a horizontal gear (267) which rotates the video camera shrouding member (261) in order to adjust the horizontal direction of the video camera (270). The other electric motor (264) drives a vertical gear (268) which controls the tilt of the video camera (270). FIG. 5D demonstrates how the video camera (270) may be received by its interior threads (272) by a video camera mounting means (273) which is adapted to receive and be in mechanical communication with the vertical drive gear (not depicted in FIG. 5B) and also shows an optional protective shade (I272) with which the lens may be protected from undesired light on this or any of the embodiments of the present invention.

Making reference now to FIG. 5C, in this alternative embodiment the video camera mounting means (260) (not depicted in FIG. 5C) may, but need not, be positioned within a harness, (291) with screws (292)

In FIG. 5D it can be seen that the exterior of the video camera mounting means (260) comprises a video camera mounting member within a harness (291) within which is a video camera mounting member (262) and video camera control means (262) including the 2 motors (264, 265), the vertical and horizontal driving gears (267, 268) (enclosed within (261) and the video camera (270). FIG. 5D shows a complete video camera mounting means (260).

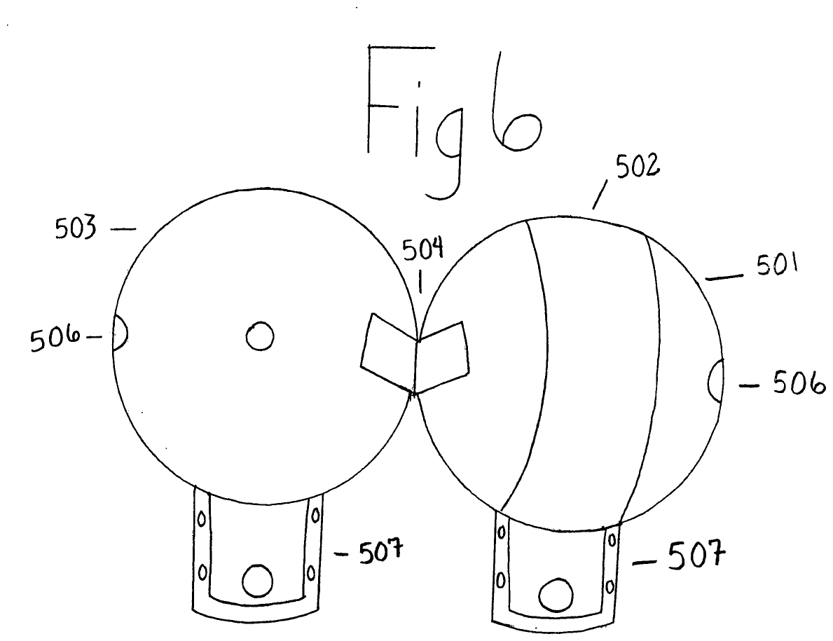

Depicted in FIG. 6 is such an optional video camera mounting means shrouding member (501), in isolation, which further comprises an elongated vertical slit (502) through which a video camera (270) may be aimed as it tilts vertically from the straight up position to the straight down position. In order to provide a measure of protection from the elements, this elongated vertical slit (502) could comprise a protective glass or transparent plastic. It comprises a folding pair (501, 503) connected by a hinge (504) and, when closed, by matching latch members (505, 506) None of these interior accessories (260-268) are depicted in FIG. 6 as they are contained and out of sight. This shrouding member (501) may also be adapted with a fastening means (505) which may be used to hold it in place so that the elongated slit (502) travels with the aim of the video camera lens. This is just an example of how the various video camera assemblies may be protected. Many other ways may be used in keeping within the spirit and scope of the present invention.

Often it will be the case that a vessel equipped with such elevation tower apparatus as described in the embodiments of the invention will be used in waters such as a lake or pond which are relatively quiet and still. In other cases, however, such a vessel will be used in bays, intercostal waterways, or in oceans where the water is choppy or even turbulent. While it is anticipated that any form of the invention taught by this application will be constructed of sturdy and strong materials, it is sill likely that there will be some movement of the assembly due to the motion of the vessel as well as some degree of flexibility which may exist in the respective elevation towers themselves. In such cases there are further adaptations, which are evident from this description and do not need depiction in the way of drawings, which maybe applied to eliminate or mitigate these circumstances. Such will be described ion more detail later in this description.

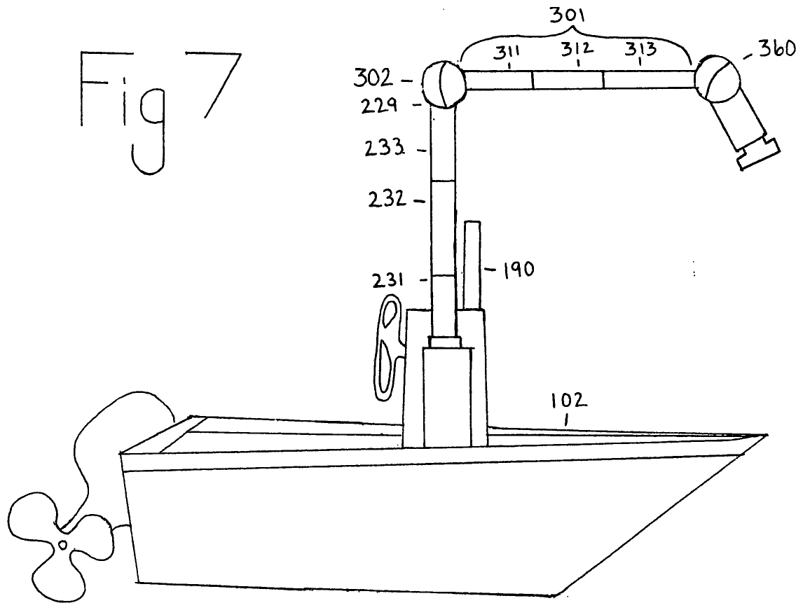

Making reference to FIG. 7, is an alternative embodiment or enhancement of the described alternative embodiment of the present invention which provides an additional utility. There may be situations in which it may be useful to extend the positioning of the video camera mount (260) to a point distant from the hull, or side of the vessel (102). For instance, the vessel (101) may be navigating in shallow water, such as when gliding along close to shore, and seeking targets of visibility (such as minnows to be used as bait) which are best viewed from directly overhead.

In such cases an extension arm assembly (301) from which an extension arm (310) is mounted can be fixed upon the top of the elevation tower (229). As can be seen in FIG. 7A, the extension arm receiving shroud (302) has a motor (303) and gears (304, 305) only for horizontal movement. The extension arm (310) may be received and fastened to the top of the elevation tower (229) with the same kind of screw-in joint (307) as the camera.

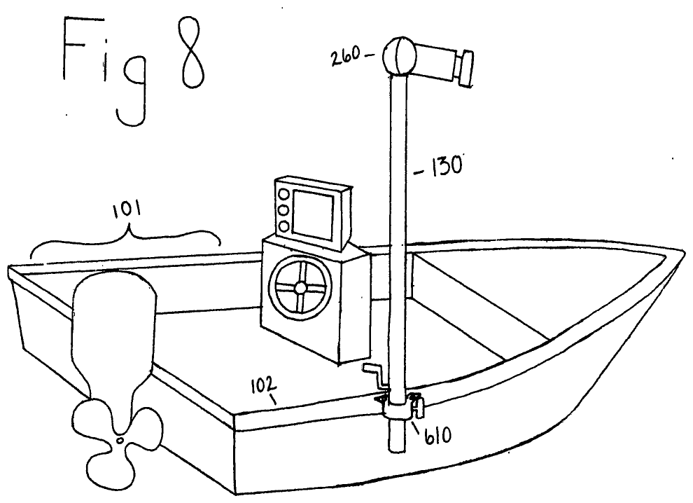

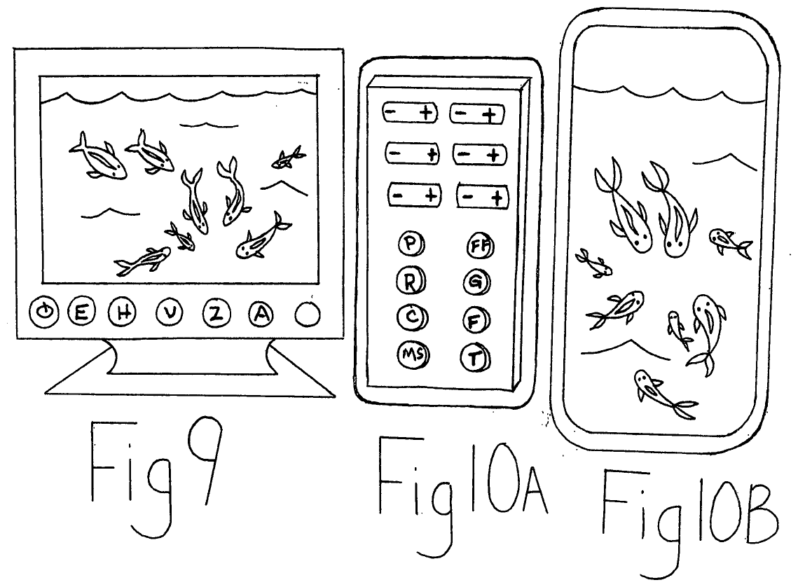

The extension arm assembly (301) further comprises an extension arm video camera mounting apparatus (360). As shown in FIG. 7B, the extension arm video camera mounting apparatus (360) further comprises an extension video camera tilt mount (361) with a video camera control gear (362) within the vertical tilt motor enclosure (365) outside the mount (360) with an electric motor (363) and vertical rotation gear (364) which only need accomplish the vertical rotation or tilt of the extension video camera (370) since the horizontal rotation is handled by the extension arm mount (310). Accordingly, from the control panel (FIGS. 9, 10A) the video camera may be fully tilted from straight up to straight down.

FIG. 7C shows the video camera mounting apparatus (360) with the video camera (370) within the extension video camera tilt mount (361) and the vertical tilt motor enclosure (365). A harness (391) similar to the one used in the telescoping tower (230) is used with mounting screws (392)

As described earlier, these components which include such parts or accessories which may be sensitive to the elements may optionally be protected by shrouding members. Having described the video camera shrouding member above (261) such is not necessary to do so again with respect to shrouds for other sensitive components of the device in any of its configurations. The concept of shrouds as protective structures is well known and the structure of any particular shroud is not a matter of the claims of this invention

Thus it can be seen that the extension video camera (370) may be extended out from the elevation tower (230) a distance from the hull of the vessel (101) equal to the length of the extension arm (310) and directed directly downward in order to get a better view of such targets as minnows, shells or other objects along the shore. This may also avoid glare of the sun which may result from an angled view and make observation of such smaller objects more difficult.

The extension arm (310), like the elevation tower (230), may be adapted of telescoping sections (311, 312, 313) in order to allow selection of a desired length or may alternatively comprise a single shaft (not depicted in this embodiment). Such could also be made of a fixed length and neither expandible or contractible.

While the alternate preferred embodiment of the present invention has been described with respect to the use of a telescoping shaft made of a metallic material and which enables the video camera apparatus to be elevated to a desired elevation under the control of an electric motor control by the operator, it should be noted that the principles of the present invention may also be practiced by the use of an elevation tower (101) which achieves its elevation by using a variety of methods. For instance, if the operator has determined that a single elevation will be appropriate for an entire trip, the elevation tower may comprise only a single shaft which is integral and cannot be adjusted for elevation. In such an embodiment it can be seen that the elevation tower material could be a sturdy plastic, wood or any other material which would be both steady and have a weight compatible with use upon the vessel to be equipped with the overall apparatus.

Additionally, rather than telescoping, the shaft may be raised and lowered through a sleeve. In such an embodiment it can be seen that there would be limitations to the degree of elevation equal to the length of the sleeve was length of the shaft less the amount of overlap between the elevation shaft and sleeve which must be overlapped in order to achieve a secure mount. Another such means would be to provide an elevation shaft which comprises two or more elevation shaft members (not depicted) which may be coupled in order to achieve an adequate elevation.

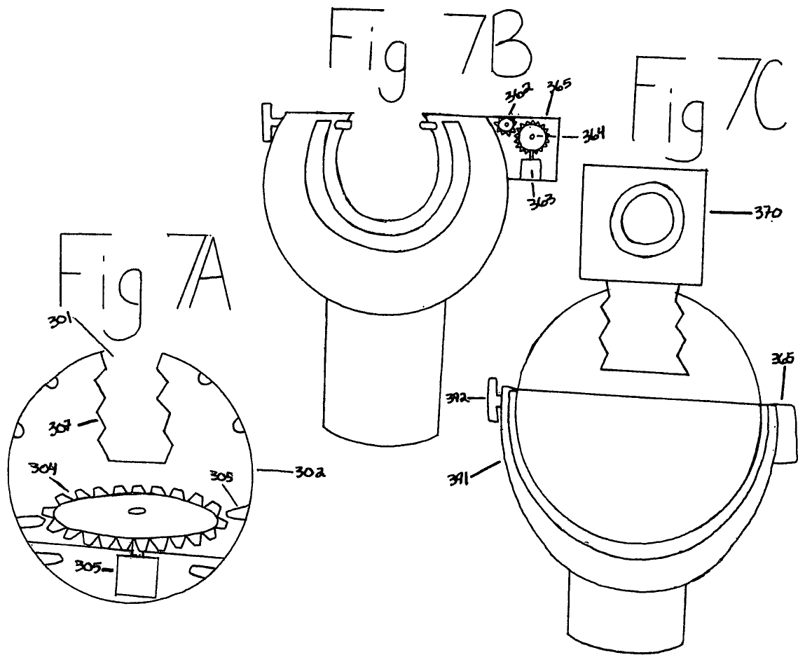

Reference is now made to FIG. 8 which depicts an alternate version of the preferred embodiment in which the cylindrical elevation tower (130) is mounted within a cylindrical sleeve (610) positioned on the outward side of the hull (102) of the vessel permitting it to be slid through the cylindrical sleeve (610) in order to adjust the elevation of the camera (170) either up or down. It should be clear that any of the embodiments would suitable for use with an exterior tower. One advantage would be that no mechanism would be needed to raise and lower the tower since such could be done simply by plunging the tower (130) as much as the depth of the surrounding water.

All of these tower adaptations can easily be seen to be within the spirit and scope of the present invention as the basic premise of each is to enhance the viewing of the immediate subsurface waters proximate to personal or small commercial vessel by elevating the point from which such are viewed with controls specific to the degree of elevation of the point from which a video camera views such proximate waters by adjusting either the degree of elevation or the stability of elevation tower material.

As conditions become more choppy, As referenced earlier, it maybe desired to provide some means of stabilizing the video camera position. When necessary or desirable, this can be accomplished by using a video camera adapted with a gyroscopic device, such as a (FLIR M500®, offered by FLIR, Inc.) or by positioning a separate gyroscope (such as a “Gyrosteady®” offered by Gyroscope.com) adapted with appropriate standard screw-in mount so that it is in stabilizing communication with the video camera (such as a 360 FLY®, offered by FLY, Inc.). Unless the waters are too turbulent this may stabilize the video camera sufficiently to allow successful viewing. All of these cameras are made with the same interior threaded screws to be received by a video camera mount, such as used in the present invention. It should also be noted that each of the covering shrouds may have to be made large enough to accommodate the extra hardware.

It should also be noted that many video cameras either are or easily may be adapted with various filters which may eliminate glare and enhance the viewing of the water from above the surface so that objects which could not be comfortably or successfully viewed through the glare can now be seen on a video monitor. Moreover, the use of an elevated night vision video camera could be most useful. Such would use the detection of infrared or heat energy to locate fish trails or other objects in the water, such as another occupied vessel, during hours of darkness to enhance both navigation safety as well as fishing. Such video camera, with or without filters and enhancements could also be tilted upward at the night sky to facilitate navigation by star formations. The absence of surrounding ambient light could produce remarkable images.

In this way it can be seen that video camera selection as well as video camera augmentation can be optionally used with the apparatus taught by the preferred embodiment of the present invention to achieve a number of goals with the invention as taught. All of these video camera adaptations can easily be seen to be within the spirit and scope of the present invention as the basic premise of each is to enhance the viewing of the immediate subsurface waters proximate to personal or small commercial vessel by elevating the point from which such are viewed with controls specific to the degree of elevation of the point from which the video camera views such proximate waters, the degree of magnification, filters for enhancing visibility from surface glare and by selecting video camera types for different circumstances, such as night vision.

It should also be noted that, both in the tower mounted video camera of the preferred embodiment, FIG. 1, and in the alternative embodiments in which the video camera (103) is mounted upon the no rotational tower (FIG. 4) or upon the extension assembly (FIG. 7), the video camera may be housed within a spherical shroud (501),

Additionally, since the shroud (501) is intended to be moved through both horizontal and vertical rotations, such spherical shape offers the same resistance to wind and rain in all directions and it can also be established that such spherical shape also offers the least resistance to the elements. Accordingly, protection of the video camera which may often be subject to damage by inclement weather and conditions is a goal of having a shroud.

It is also noted that the preferred embodiment of the present invention as well as the preferred embodiment further adapted with an extension arm (FIG. 7), depend upon the ability to automatically adjust both the elevation of the video camera as well as the length of the extension arm. Accordingly, some mechanism for achieving precise control over these components is necessary for successful operation of the invention. There are a variety of alternatives for achieving such goal, some of which are readily available through commercial products.

For instance, such objective of raising and lowering the elevation of the tower could be accomplished by the use of a hydraulic chamber which may be expanded or contracted as necessary to achieve a desired elevation. Such apparatus may comprise a hydraulic chamber housed within the telescoping tower which may be expanded by pumping fluid from a fluid reservoir within the tower's telescoping sections to raise the video camera apparatus or contracted by allowing such hydraulic fluid to be drained back into the reservoir so as to allow such tower's sections to be contracted and to lower the video camera apparatus.

Alternatively, such control may be achieved by the use of an electric motor apparatus, such apparatus in mechanical communication with such tower to enable precise control of the elevation. Moreover, such control could also and in a cost-effective and reliable manner be achieved by a simple hand crank which could be used to raise and lower the tower.

Additionally, manual control of both the rotation and tilt of the video camera could be achieved by use of manual controls. Such could include a simple fully to control the tilt of the video camera as well as a means of rotating the tower shaft itself manually, either by simply twisting the shaft or by doing so with a pulley or gear mechanism to enable the tower shaft, upon which the video camera apparatus or, alternatively, the extension arm and the video camera apparatus are mounted so that such can be done with reduced resistance.

All the above mentioned methods and means should be seen as keeping within the spirit and scope of the present invention as all such alternative embodiments are designed to achieve the stated objectives of the present invention and should be seen as included within the specification and claims of the present invention as described. It should also be noted that no effort is being made to claim the operation of such hydraulic or mechanical lifts or of the use of levers to control elevation, rotation or tilt of the video camera apparatus.

That being said, it is herein mentioned that there are some commercially available video cameras which are sufficiently adapted to be used in such conditions without additional protection and in which a shroud for protection only would be unnecessary. Additionally, the direction controlling mechanism need not depend on the existence of a shroud or any mounting apparatus other than one which remains open to the elements.

Accordingly, while the use of a spherical shroud has been taught in the preferred and alternative embodiments of the present invention, such an apparatus could be made using a shroud comprising a square or rectangular box, a triangular box, or any manner of enclosed space at all. Additionally, the shroud should be seen as optional in that the use of a sufficiently weather resistant video camera may make a shroud unnecessary or the owner and operator of a given vessel may be determined to engage the present invention only at times when inclement weather is not an issue.

Accordingly, the use of a non-spherical shroud or protecting the present invention with no shroud at all should be seen as keeping within the spirit and scope of the present invention since such an apparatus without a shroud or with a non-spherical shroud would still be fully capable of achieving all of the primary objectives of the present invention. Consequently, such alternatives should be seen as fully included and described in the present description and included within the scope of the following claims.

It should be noted that such shrouding apparatus for the embodiment of the invention in which the extension arm is horizontally rotated from its mounting point on the top of a tower separately from the vertical rotation of the video camera, separate trials or covers may be deployed to protect both electrical motors from the elements. This would be a simple matter for anyone for any one skilled in the art of mechanized movement and need not be herein described in great detail. Additionally, such a shroud could take any shape or form so long as it satisfied the functions of allowing the desired movements and protecting the motors and years and necessary circuitry.

Having made these observations it is now appropriate to observe that all of these tower and camera adjustments, which were first described as made manually in the preferred embodiment, may be made remotely. Also described in the preferred embodiments of the present invention is a control panel, upon which is provided the remote controls for the elevation of the tower and for the rotation and tilt of the video camera apparatus.

FIG. 10A depicts how a control panel built into a video monitor may appear. FIG. 10B depicts how a smart phone in the control mode of the system may appear. Essentially the controls could, but need not, be designed such that touching one side of a button increases the desired parameter, such as increasing elevation, tilt, horizontal aim from a set zero point, or increasing the zoom of the lens or camera aperture. Touching the other side of the button which simply decrease the same parameters. FIG. 10C is the screen of the smart phone when set in the image mode and such would present the image, in real-time, from the video camera.

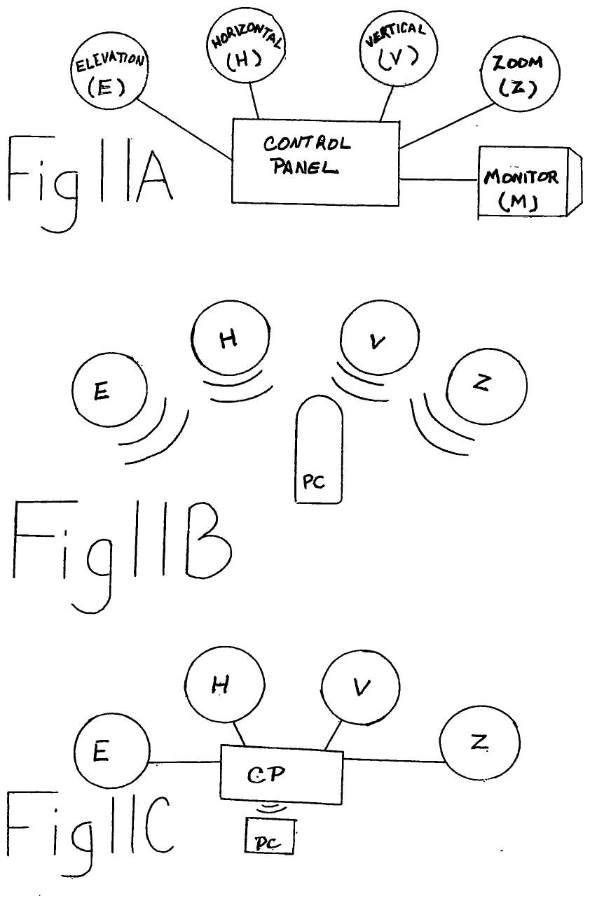

FIG. 11A schematically depicts the electronic communication between a control panel and the elevation adjustment, the horizontal angle adjustment, the vertical tilt adjustment, the camera zoom adjustment, and the video monitor.

It is envisioned that such a control panel could be housed proximate to the navigational wheel of the vessel or, alternatively, in a control panel built into the elevation tower mounting means. In either case there would be separate components which may be an electrical communication with the means for achieving elevation of the tower, and rotation and tilt of the video camera apparatus or extension of the horizontal arm.

Additionally, the monitor for viewing the images from the video camera apparatus may be provided within such control panel or by a separate video monitor such that control and use of the apparatus may be from any convenient location within electrical communication of the desired components of the invention. Such has been a convenient way of describing the use of the apparatus. An example of such a monitor is depicted in FIG. 9. Shown are knobs for control of elevation, E; horizontal camera direction, H; vertical tilt, V; zoom lens setting, Z; aperture setting, A; and a spare. The monitor controls, as depicted, are, but need not be, knob type. When not using wireless the schematic is as in FIG. 11A.

FIG. 10A depicts the control screen (981) of a portable computing device (980) (such as, but not limited to a smart phone) in the fish finder (FF) app in the control mode. FIG. 10B depicts an image screen (982) when app “FF” is in image mode. The corresponding control parameters may be made to the desired embodiment of the invention either directly, FIG. 11B or through a wireless receiver on the monitor or 11C if direct wireless communication between the device (980) and the apparatus is desired.

It should be mentioned, however, that the present-day state of the art built into such everyday technology, such as smartphones, so-called tablets, and laptops and thinkpads and the like make it possible for all the features of the present invention to be remotely controlled and enjoyed remotely and without the need for direct electrical communication between the control panel and the components to be controlled. Applications (which are commonly called “apps”) can be developed to achieve the exercise of total control of the components of the invention as well as viewing the images produced by the video camera apparatus on or by any of these devices. In essence, the applications, or apps, designed for this purpose essentially result in the smart phone or other remote apparatus in electromagnetic communication with the components becoming the control panel and video monitor itself. FIG. 11B schematically depicts the electromagnetic wave communication between a smart phone, tablet, or computer adapted with wireless or Bluetooth capability, and the elevation adjustment, the horizontal angle adjustment, the vertical tilt adjustment, the camera zoom adjustment, and a monitor apart from the controlling device if supply.

Moreover, the wireless electronic communication may alternatively be established, by either Bluetooth or Wi-Fi, with the control panel rather than direct electronic communication with the motors and video camera. FIG. 11C schematically depicts electromagnetic communication between a smart phone, a tablet, or wirelessly equipped computer and a control panel which is, as in FIG. 11A, in electrical communication with the elevation adjustment, the horizontal angle adjustment, the vertical adjustment, the camera zoom adjustment, and the video monitor. This may prove to be a more effective way of establishing such electromagnetic remote control of the components. It should again be noted that each of these means of establishing either electric or electromagnetic communication for control and viewing of the video camera orientation and images are well within the scope of the present invention as each are separate means of remotely controlling and viewing such parameters. Accordingly, each such alternative and others which may be utilized should be seen as keeping within the spirit and scope of the present invention and, accordingly, included within the scope of its claims.

It should be noted that no effort is made to claim any such application itself as such applications may be separately developed by those with computing skills, Such control apps would only be as complex as turning on a motor control for the desired elevation, rotation and tilt of the lens and, possibly the zoom lens to achieve a proper magnification. Such skills are well-known in the present state of the software art. But it should also be noted that such alternative means of controlling the apparatus and viewing the resulting images should be seen as keeping within the spirit and scope of the present invention as such we use all of the described components of the present invention in the manner so described. Accordingly, each such application or control means should be seen as fairly included within the scope and description of the present invention and its claims.

Having made these observations it is now appropriate to observe that all of these tower and camera adjustments, which were first described as made manually in the preferred embodiment, may be made remotely as shown. Also described in the preferred embodiments of the present invention is a control panel, upon which is provided the remote controls for the elevation of the tower and for the rotation and tilt of the video camera apparatus.

It is envisioned that such a control panel could be housed proximate to the navigational wheel of the vessel or, alternatively, in a control panel built into the elevation tower mounting means. In either case there would be separate components which may be an electrical communication with the means for achieving elevation of the tower, and rotation and tilt of the video camera apparatus or extension of the horizontal arm. Additionally, the monitor for viewing the images from the video camera apparatus may be provided within such control panel or by a separate video monitor such that control and use of the apparatus may be from any convenient location within electrical communication of the desired components of the invention. Such has been a convenient way of describing the use of the apparatus.

It should also be noted that no effort is made to claim such an application itself as such applications may be separately developed by those with computing skills and such skills are well-known in the present state of the art. But it should also be noted that such alternative means of controlling the apparatus and viewing the resulting images should be seen as keeping within the spirit and scope of the present invention as such we use all of the described components of the present invention in the manner so described. Accordingly, each such application or control means should be seen as fairly included within the scope and description of the present invention and its claims.

Each of the embodiments described herein have been described with respect to elevating towers which are cylindrical in shape. It should be noted, however, that the only requirement of the elevating tower in any of the embodiments of this invention is that they are substantially straight and upright and of sufficient strength to securely support the weight of either the video camera apparatus or the video camera apparatus and an extension arm depending upon the embodiment. Accordingly, it should be further observed that an irregularly shaped elevation tower may be used in the primary embodiment, so long as the mounting sleeve was adapted to permit the rotation of such irregularly shaped elevation tower.

Moreover, with respect to the alternate and enhanced alternate embodiments of the present invention it should also be noted that the cross-sectional shape of the elevation tower does not need to rotate and was depicted in the drawings as cylindrical only because of the possibility of telescoping members. If telescoping members are not used for the elevation tower an extension arm, then any cross-sectional shape of the elevation tower and extension arm are possible. In such case adjustable elevation of the tower could still be accomplished either by allowing an integral elevation tower to be lowered and raised through interior space below the deck or through an elevation tower mounting means outside the hull of the vessel as depicted in (401) of FIG. 8, in which an integral elevation tower may be raised and lowered through the depth of the water in which the vessel is deployed.

The various forms and shapes of elevation towers are, therefore, not critical to the operation of the invention and no effort is made to claim any particular form or shape of elevation tower beyond what is described and claimed other than that each such form or shape must be capable of substantially upright deployment and sufficient strength to hold the video camera apparatus or extension arm and video camera apparatus as to be used in any given embodiment. Accordingly, each such form and shape of elevation tower should be seen as included within the spirit and scope of the present invention and as falling within its claims.

Further modification and variation can be made to the disclosed embodiments without departing from the subject and spirit of the invention as defined in the following claims. All such modifications and variations, as included within the scope of these claims, are meant to be considered part of the invention as described.

What is claimed is:

1. An apparatus useful to the pilot, crew or interested passenger of a vessel in obtaining an improved view of the surrounding subsurface waters from said vessel, which may include a fishing vessel, as it navigates through waters which are substantially clear, the invention further comprising;
a cylindrical tower which is adapted to receive and securely fasten a video camera mount apparatus at a desired elevation, said cylindrical tower being further secured to a convenient surface on a vessel by a cylindrical tower base member so that said cylindrical tower may be rotated through a full 360° radius and so that a video camera mounted within said video camera mount apparatus will rotate within a horizontal plane and can be aimed in any desired horizontal rotation from 0° to 360°;
said video camera mount apparatus further comprising a video camera mounting member, said video camera mounting member being adapted to securely mount and fasten said video camera such that said video camera is aimed generally in the direction opposite from said tower;
said video camera mounting member further being adapted to permit said vertical plane video camera rotational adjustment means to allow said video camera to rotated vertically so that it may be aimed at any vertical orientation from near 0° (or straight up from the deck of the vessel or surrounding water) to 180° (or straight down to the deck of the vessel or surrounding water)l;
said vertical rotation mounting means may further comprise said video camera being mounted to a flat circular disk by means of a mounting member flat disk within the same plane of said flat disk and which may be held in place by a clamp member extending out from said tower, which may further be tightened so as to permit the vertical angle of said video camera to be securely positioned at any desired vertical rotation from an upper vertical angle near 180° (or straight down to the deck of the vessel or surrounding water) to 0° (or straight up from the deck of the vessel or surrounding water);
said video camera further being in electrical communication with a video monitor so as to enable the images from said video camera to be displayed upon said video monitor at or near said that level of said vessel.

2. The apparatus useful to the pilot, crew or interested passenger in obtaining an improved view of the surrounding subsurface waters of a vessel, which may include a fishing vessel described in claim 1 which is further adapted to more conveniently be adjusted in the following matters;
wherein said tower is further adapted with video camera mount apparatus elevation means to permit the video camera mount may be elevated at a desired elevation along the length of the tower as desired and control from a pilot, crew member or interested passenger from said deck level;
and a mechanical means of adjusting the degree of elevation so that it may be controlled from the pilot, crew member or interested passenger from the deck level from which the apparatus is mounted.

3. The invention described in claim 2 which is further adapted to more conveniently adjust the vertical rotation of the video camera by establishing a mechanical communication between the video camera mount apparatus elevation means, said vertical rotation adjustment means further comprising;
a video camera mounted from a flat video camera mounting disk which is further sandwiched between a clamp which is sufficiently secure to hold the flat video camera mounting disk securely in place when desired but not so secure as to prohibit rotation of the flat video camera mounting disk when appropriate;
said video camera further being adapted with a low vertical angle line which may be used to adjust the video camera angle downwardly and further may comprise a lower positioning line connection to a video camera position through a tower pulley, and in which said low angle line extends down to the deck level so that it may be pulled by a pilot, crew or interested passenger into a desired lower vertical video camera angle, and a high vertical angle line which may be used to adjust the video camera angle upwardly and further may comprise an upper positioning line connection to a video camera position through a tower pulley, and in which said upper angle line extends down to the deck level so that it may be pulled by a pilot, crew or interested passenger at said deck level into a desired upper vertical angle.

4. An apparatus useful to the pilot, crew or interested passenger of a vessel in obtaining an improved view of the surrounding subsurface waters from said vessel, which may include a fishing vessel, as it navigates through waters which are substantially clear, as described in claim 1 the invention further comprising;
said cylindrical tower member further comprising a vertical slot extending along the length of said tower member from a point near its top to a point near the said tower member base;
the interior of said cylindrical tower member being further adapted with an upper pulley mounted from the interior top of said cylindrical tower member and a lower pulley mounted to a point below the end of said vertical slot and a pulley line which passes through the said upper pulley member and lower pulley member,
said pulley line further securing a portion of said video camera mount apparatus which extends through said vertical slot, enabling said video camera mount apparatus to be raised and lowered by means of its connection to said pulley line;
said lower pulley being further in mechanical communication with a crankshaft which extends through said cylindrical tower and enables said video camera mounting apparatus to be raised and lowered at any point along said vertical slot by turning a crank which is in mechanical communication with said crankshaft.

5. An apparatus useful to the pilot, crew or interested passenger of a vessel in obtaining an improved view of the surrounding subsurface waters from said vessel, which may include a fishing vessel, as it navigates through waters which are substantially clear, as described in claim 4 the invention further comprising;
adapting said crankshaft to be in mechanical communication with a motor, enabling said crankshaft to be powered by said motor which may be switched on or off in either direction so as to power the precise raising and lowering of said video camera mount apparatus with said motor.

6. An apparatus useful to the pilot, crew or interested passenger of a vessel in obtaining an improved view of the surrounding subsurface waters from said vessel, which may include a fishing vessel, as it navigates through waters which are substantially clear as is described in claim 1, the invention further comprising;
adapting said video camera mount apparatus with an elongated mounting extension, said elongated mounting extension being further adapted to be mounted upon said cylindrical tower on one end and to receive said video camera mount apparatus on the other end so as to provide a degree of separation between said cylindrical tower member and said video camera mount apparatus.

7. An apparatus useful to the pilot, crew or interested passenger of a vessel in obtaining an improved view of the surrounding subsurface waters from said vessel, which may include a fishing vessel, as it navigates through waters which are substantially clear as is described in claim 5, the invention further comprising;
adapting said video camera mount apparatus with an elongated mounting extension, said elongated mounting extension being further adapted to be mounted upon said cylindrical tower on one end and to receive said video camera mount apparatus on the other end so as to provide a degree of separation between said cylindrical tower member and said video camera mount apparatus.

8. An apparatus useful to the pilot, crew or interested passenger of a vessel in obtaining an improved view of the surrounding subsurface waters from said vessel, which may include a fishing vessel, as it navigates through waters which are substantially clear as is described in claim 6, the invention further comprising;
adapting said video camera mount apparatus with an elongated mounting extension, said elongated mounting extension being further adapted to be mounted upon said cylindrical tower on one end and to receive said video camera mount apparatus on the other end so as to provide a degree of separation between said cylindrical tower member and said video camera mount apparatus

9. An apparatus useful to the pilot, crew or interested passenger in obtaining an improved view of the surrounding subsurface waters of a vessel, which may include a fishing vessel, as it navigates through waters which are substantially clear, the invention further comprising;
a tower which is adapted to receive and securely fasten a video camera mount apparatus at a position secured at the top of such tower, such tower being further secured to a convenient surface on a vessel by a tower base member;
said video camera mount apparatus further comprising a video camera mounting member, said mounting member being adapted to securely mount and fasten a video camera such that said video camera is aimed generally in the direction opposite from said tower;
said video camera mount apparatus further comprising a video camera shroud member within which said video camera may be all or partially enclosed, said video camera shroud member further comprising a vertical slit through which said video camera may be aimed and rotated vertically at any desired vertical rotation from an upper vertical angle near 180° (or straight up from the deck of the vessel or surrounding water) to 0° (or straight down to the deck of the vessel or surrounding water);
said video camera mount apparatus further comprising electrical means for vertical rotation of said video camera vertically at any desired vertical rotation from an upper vertical angle near 180° (or straight up from the deck of the vessel or surrounding water) to 0° (or straight down to the deck of the vessel or surrounding water), said video camera mount apparatus further comprising electrical horizontal rotational means for horizontal rotation of said video camera said electrical horizontal traditional means being in electrical communication with a horizontal rotational control means positioned so that it may be controlled by a pilot, crew or interested passenger at said deck level into a desired upper horizontal angle;
said video camera mount apparatus further comprising electrical horizontal rotational means for horizontal rotation of said video camera said electrical horizontal traditional means being in electrical communication with a horizontal rotational control means positioned so that it may be controlled by a pilot, crew or interested passenger at said deck level into a desired upper horizontal angle said video camera mount apparatus further comprising electrical horizontal rotational means for horizontal rotation of said video camera said electrical horizontal traditional means being in electrical communication with a horizontal rotational control means positioned so that it may be controlled by a pilot, crew or interested passenger at said deck level into a desired upper horizontal angle; and
said video camera further being in electrical communication with a video monitor so as to enable the images from said video camera to be displayed upon said video monitor at or near said that level of said vessel.

10. An apparatus useful to the pilot, crew or interested passenger in obtaining an improved view of the surrounding subsurface waters of a vessel, which may include a fishing vessel, as it navigates through waters which are substantially clear as described in claim 9, the invention further comprising means for remotely;
elevation means for said tower, said tower elevation means further comprising apparatus whereby said tower top may be elevated or lowered so that said video camera will be at a desired level of elevation.

11. An apparatus useful to the pilot, crew or interested passenger in obtaining an improved view of the surrounding subsurface waters of a vessel, which may include a fishing vessel, as it navigates through waters which are substantially clear as described in claim 10, the invention further comprising;
the adaption of said tower to be comprised of telescoping members which may be contracted to a lower elevation so as to allow the pilot, crew or interested passenger of a vessel access to said video camera mounting means in order to perform the necessary operations on the components of said video camera mounting means or said telescoping members may be fully extended to the desires upper elevation so as to allow the video camera to receive an image from the highest elevation allowed by said telescoping tower or said telescoping members may be positioned at any point in between said lower level and said upper level.

12. An apparatus useful to the pilot, crew or interested passenger in obtaining an improved view of the surrounding subsurface waters of a vessel, which may include a fishing vessel, as it navigates through waters which are substantially clear as described in claim 11, the invention further comprising;
elevation means for said video camera in which said elevation means comprises adapting said telescoping members to be contracted to said lower level or extended to said upper level by mechanical elevation means or positioned at any point between, said mechanical elevation means being adapted to be controlled by the pilot, crew or interested passenger at the deck level of said vessel.

13. An apparatus useful to the pilot, crew or interested passenger in obtaining an improved view of the surrounding subsurface waters of a vessel, which may include a fishing vessel, as it navigates through waters which are substantially clear as described in claim 11, the invention further comprising;
adapting the interior of said telescoping members may be adapted to receive and securely containing a hydraulic fluid which may be popped into the said interior of said telescoping members to cause it to extend said telescoping members or be drained from said interior of said telescoping members to allow said telescoping members to be contracted.

14. An apparatus useful to the pilot, crew or interested passenger in obtaining an improved view of the surrounding subsurface waters of a vessel, which may include a fishing vessel, as it navigates through waters which are substantially clear as described in claim 10 the invention further comprising;
elevation means for said video camera, said video camera elevation means further comprising apparatus whereby said tower top may be elevated or lowered so that said video camera will be at a desired level of elevation in which said video camera elevation means apparatus further comprises;
a cylindrical tower member, said cylindrical tower member being adapted to pass through a cylindrical tower member sleeve, said cylindrical tower member sleeve being adapted with an interior diameter very close to said cylindrical tower member outer diameter and with tightening means so that said cylindrical tower member sleeve maybe listen to permit said cylindrical tower member to pass through said cylindrical tower member sleeve vertically in either direction;
said cylindrical tower member sleeve further being mounted to the vessel such that said cylindrical tower member sleeve will be positioned immediately outside the vessel so that, in the cylindrical tower member upper position the bottom of said cylindrical tower member will be near the sleeve and that, in the cylindrical tower member lower position, the bottom of said cylindrical tower may be lowered as much as the depth of the water surrounding the vessel will permit.

15. An apparatus useful to the pilot, crew or interested passenger in obtaining an improved view of the surrounding subsurface waters of a vessel, which may include a fishing vessel, as it navigates through waters which are substantially clear as described in claim 14 the invention further comprising;
further adapting said cylindrical tower means with a motor to move said cylindrical tower means up and down, said power means further comprising electrical communication with a control means which is adapted to alternatively loosen and tighten said cylindrical tower member sleeve to permit said cylindrical tower member to be moved up or down as desired and also to control said motor in order to power said upward and downward movement of the cylindrical tower means.
a tower securely mounted upon a vessel, said tower being mounted in a substantially upright orientation from a mount within a cylindrical sleeve and said mount so that said tower may rotate a full 360°;
said tower further comprising an extension arm at or near the upper end of said tower, said extension arm being securely fastened to said upper end of said tower at one end and, at its other end, being adapted to receive a video camera means;
said video camera means being capable of allowing a video camera within said video camera means to be vertically rotated from a point at which said video camera is oriented to receive images from straight up into the sky to a point at which said video camera is oriented straight down into the water surrounding said vessel;
said video camera further being in electrical communication with a video monitor so as to enable the images from said video camera to be displayed upon said video monitor at or near said that level of said vessel.

17. An apparatus useful to the pilot, crew or interested passenger of a vessel in obtaining an improved view of the immediately surrounding subsurface waters from said vessel, which may include a fishing vessel, as it navigates through waters which are substantially clear as described in claim 16 the invention further comprising;
said video camera mount apparatus further comprising a video camera shroud member within which said video camera may be all or partially enclosed, said video camera shroud member further comprising a vertical slit through which said video camera may be aimed and rotated vertically at any desired vertical rotation from an upper vertical angle near 180° (or straight up from the deck of the vessel or surrounding water) to 0° (or straight down to the deck of the vessel or surrounding water).

18. An apparatus useful to the pilot, crew or interested passenger of a vessel in obtaining an improved view of the immediately surrounding subsurface waters from said vessel, which may include a fishing vessel, as it navigates through waters which are substantially clear as described in claim 15 the invention further comprising:
electronic control means comprising electronic conductors running between a control panel and each adjustable component by which said component may be adjusted by electronic controls on said control panel.

19. An apparatus useful to the pilot, crew or interested passenger of a vessel in obtaining an improved view of the immediately surrounding subsurface waters from said vessel, which may include a fishing vessel, as it navigates through waters which are substantially clear as described in claim 15 the invention further comprising:
electromagnetic control means, said electromagnetic control means further comprising a portable computing device, said computing device further comprising electromagnetic transmission and reception means and a video display,
each adjustable component of said video camera apparatus further comprising an electromagnetic transmission and reception means in electromagnetic communication with said electromagnetic control means so that he said adjustable component may be controlled from said portable computing device and the images from said video camera may be viewed on the display of said computing device.

20. An apparatus useful to the pilot, crew or interested passenger of a vessel in obtaining an improved view of the immediately surrounding subsurface waters from said vessel, which may include a fishing vessel, as it navigates through waters which are substantially clear as described in claim 18 the invention further comprising:
remote electromagnetic control panel control means, said remote electromagnetic control panel control means further comprising a portable computing device, said portable computing device being in electromagnetic reception and transmission communication with said control means and further being adapted to remotely adjust each component through said control means.
